(19) United States
(12) Patent Application Publication
(10) Pub. No.: US 2025/0333610 A1
(43) Pub. Date: Oct. 30, 2025

(54) INTUMESCENT COATINGS

(71) Applicant: SWIMC LLC, Cleveland, OH (US)

(72) Inventor: Elio MORELLI, Bologna (IT)

(21) Appl. No.: 18/855,375

(22) PCT Filed: Apr. 11, 2023
(86) PCT No.: PCT/US2023/065625

§ 371 Date: Oct. 9, 2024

Related U.S. Application Data
(60) Provisional application No. 63/329,995, filed on Apr. 12, 2022.

(51) Int. Cl. C09D 5/18; C09D 7/61; C09D 101/14; C09D 101/18; C09D 175/04

(52) U.S. Cl. CPC C09D 5/185; C09D 7/61; C09D 101/14; C09D 101/18; C09D 175/04

(57) ABSTRACT

The present application relates to an intumescent coating comprising: 1) at least one cellulose film forming agent; 2) at least one polyol; 3) at least one ammonium polyphosphate compound; and 4) at least one crosslinker; wherein at least one polyol is reacted with at least one crosslinker. Alternatively, an intumescent coating may comprise: 1) at least one cellulose film forming agent; 2) at least one urea-based resin; 3) at least one polyol; 4) at least one acid; and 5) at least one ammonium polyphosphate compound; wherein at least one polyol is reacted with at least one urea-based resin and at least one crosslinking catalyst. Also described is a substrate with the intumescent coating described herein and a process of preparing the intumescent coating described herein.

### CROSS REFERENCE TO RELATED APPLICATION

This application is an international patent application which claims the benefit of U.S. Provisional Patent Application No. 63/329,995, filed on Apr. 12, 2022, the entire contents of which is incorporated herein by reference.

### FIELD

The present application relates generally to an intumescent coating. The intumescent coating may comprise: 1) at least one cellulose film forming agent; 2) at least one polyol; 3) at least one ammonium polyphosphate compound; and 4) at least one crosslinker; wherein at least one polyol is reacted with at least one crosslinker. Alternatively, the intumescent coating may comprise: 1) at least one cellulose film forming agent; 2) at least one urea-based resin; 3) at least one polyol; 4) at least one acid; and 5) at least one ammonium polyphosphate compound; wherein at least one polyol is reacted with at least one urea-based resin and at least one crosslinker. A substrate with the intumescent coating described herein and a process of preparing the intumescent coatings described herein are also disclosed.

### BACKGROUND

Intumescent paint or intumescent coatings (collectively, “intumescent coatings”) are generally applied to the surface of a substrate to change the flaming characteristics of the surface of the substrate, so as to retard the rapid spread of fire, particularly cellulosic fires. A cellulosic fire is one characterized by a fuel source such as wood, paper, textiles, and other cellulose-based materials. In industry, intumescent coatings are applied to, for example, construction elements to increase the fire resistance limit of such elements. Intumescent coatings act to passively increase the resistance to fire. When exposed to extreme temperatures, these coatings may expand and act as an insulator.

The secret behind these coatings lies in their chemical makeup. An intumescent coating may comprise a binder and other materials that soften in response to heat exposure and later hardens into an insulating material called “char.” For the intumescent coating to be effective, the insulating layer of char needs to have enough strength to provide fire protection and protect the substrate from damage resulting from exposure to high temperatures. Such protective layer has a relatively low thermal conductivity, thereby stopping rapid thermal conduction. Intumescent coatings are used on many structures to delay the heating effects of a fire. The coating slows the rate of temperature increase of the substrate to which the coating is applied. The coating thus increases the time before the structure fails due to the heat of fire. The extra time makes it more likely that the fire may be extinguished or cooled with water before the structure fails.

Currently, European legislation requires Class B rated material according to European EN 13501 to be used inside certain commercial buildings, including but not limited to retail stores, hotels, and theaters. Although a “B” rating norm may be achieved by using intumescent coating, it often comes at the cost of poor appearance as well as poor chemical resistance and other properties. Manufacturers and consumers, especially those for wood coatings, have increasingly demanded improved properties and appearances for intumescent coatings similar to a 2K solvent based polyurethane coating. In view of these challenges with many conventional intumescent coatings, the need therefore remains for improved intumescent coatings having a B rating according to European EN 13501, improved clarity and appearance, chemical resistance, and other improved properties as well as other advantages.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

An intumescent coating and processes of preparing are shown and described. The intumescent coating comprises: 1) at least one cellulose film forming agent; 2) at least one polyol; 3) at least one ammonium polyphosphate compound; and 4) at least one crosslinker; wherein at least one polyol is reacted with at least one crosslinker. Alternatively, an intumescent coating may comprise: 1) at least one cellulose film forming agent; 2) at least one urea-based resin; 3) at least one polyol; 4) at least one acid; and 5) at least one ammonium polyphosphate compound; wherein at least one polyol is reacted with at least one urea-based resin and at least one crosslinking catalyst.

Also described is a substrate with the intumescent coating described herein. A process of preparing the intumescent coating is also described herein.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to coatings that provide advantageous improvements over current intumescent coatings. It has been discovered that the use of particular intumescent coatings, namely an intumescent coating comprising: 1) at least one cellulose film forming agent; 2) at least one polyol; 3) at least one ammonium polyphosphate compound; and 4) at least one crosslinker; wherein at least one polyol is reacted with at least one crosslinker, and, alternatively, an intumescent coating comprising: 1) at least one cellulose film forming agent; 2) at least one urea-based resin; 3) at least one polyol; 4) at least one acid; and 5) at least one ammonium polyphosphate compound; wherein at least one polyol is reacted with at least one urea-based resin and at least one crosslinking catalyst, when used in intumescent coatings having a B rating according to European EN 13501, improved clarity and appearance, chemical resistance, and other improved properties as well as other advantages.

In many embodiments, the intumescent coating is a paint, stain, varnish, clearcoat, lacquer, drying oil, or film. In many embodiments, the intumescent coating is a surface treatment, primer, intermediate coat, or topcoat. The intumescent coating described herein may show particular utility as clear coats, clear base coats, pigmented base coats, clear top coats, pigmented top coats, primers, and other coatings. In one embodiment, the coating is at least partially coated onto a base coat. The intumescent coating described herein is particularly suitable in the preparation of substrates, including but not limited to metal, plastics, wood, ceramics, cement, paper, fabric, composites, or combinations thereof.

Intumescent Coating with Polyurethane

In some embodiments, an intumescent coating may comprise: 1) at least one cellulose film forming agent; 2) at least one polyol; 3) at least one ammonium polyphosphate compound; and 4) at least one crosslinker; wherein at least one polyol is reacted with at least one crosslinker. The intumescent coating described herein may provide a Class B rating, according to EN 13823 Single Burning Item. Although the intumescent coating described may be prepared as a clear coating, it may also be pigmented and still provide a Class B rating.

In many embodiments, at least one cellulose film forming agent in the intumescent coating is cellulose nitrate, cellulose ester, or combinations thereof. In some embodiments, the cellulose ester is cellulose acetate propionate (CAP), cellulose ester butyrate (CAB), or combinations thereof. Although not bound by theory, at least one cellulose film may allow the intumescent coating to be thermoplastic enough to produce intumescence when exposed to fire, and the presence of nitrogen and oxygen inside the film is believed to speed up the char formation

In many embodiments, at least one cellulose film forming agent comprises from 5% to 40% by weight of the intumescent coating. In other embodiments, at least one cellulose film can, for example, range from about 5% to about 35% by weight, from about 5% to about 30% by weight, from about 10% to about 40% by weight, from about 10% to about 35% by weight, from about 10% to about 30% by weight, from about 15% to about 40% by weight, from about 15% to about 35% by weight, from about 15% to about 30% by weight, from about 15% to about 25% by weight, from about 20% to about 40% by weight, and from about 20% to about 35% by weight. Other ranges are also contemplated.

In many embodiments, at least one polyol has at least 2 hydroxyl groups. In some embodiments, at least one polyol comprises at least one polyether polyol, at least one polyester polyol, or combinations thereof. In one embodiment, at least one polyol comprises pentaerythritol, dipentaerythritol, tripentaerythritol, or combinations thereof.

In many embodiments, at least one polyol comprises from 2% to 40% by weight of the intumescent coating. In other embodiments, at least one polyol can, for example, range from about 2% to about 35% by weight, from about 5% to about 50% by weight, from about 5% to about 40% by weight, from about 5% to about 35% by weight, from about 5% to about 30% by weight, from about 10% to about 40% by weight, from about 10% to about 35% by weight, from about 10% to about 30% by weight, from about 15% to about 40% by weight, from about 15% to about 35% by weight, from about 15% to about 30% by weight, from about 15% to about 25% by weight, from about 20% to about 40% by weight, and from about 20% to about 35% by weight. Other ranges are also contemplated.

In many embodiments, at least one ammonium phosphate comprises monoammonium phosphate, diammonium phosphate, ammonium polyphosphate, or combinations thereof.

In many embodiments, at least one ammonium phosphate comprises from 10% to 50% by weight of the intumescent coating. In other embodiments, at least one ammonium phosphate can, for example, range from about 10% to about 45% by weight, from about 10% to about 40% by weight, from about 10% to about 35% by weight, from about 15% to about 50% by weight, from about 15% to about 45% by weight, from about 15% to about 40% by weight, from about 20% to about 50% by weight, from about 20% to about 45% by weight, from about 20% to about 40% by weight, from about 25% to about 50% by weight, from about 25% to about 45% by weight, from about 25% to about 40% by weight, from about 30% to about 50% by weight, and from about 30% to about 45% by weight. Other ranges are also contemplated.

In many embodiments, at least one crosslinker comprises 1) at least one compound having two or more hydroxyl groups, 2) at least one urea or modified urea resin with at least one acid, 3) at least one isocyanate, or 4) combinations thereof. In one embodiment, the at least one isocyanate is toluene diisocyanate (TDI), toluene diisocyanate (TDI) derivative, methylene diphenyl diisocyanate (MDI), methylene diphenyl diisocyanate (MDI) derivative, hexamethylene diisocyanate (HDI), hexamethylene diisocyanate (HDI) derivative, or combinations thereof.

In many embodiments, at least one crosslinker comprises from 3% to 30% by weight of the intumescent coating when the crosslinker is measured as dry and without solvents. In other embodiments, at least one crosslinker can, for example, range from about 3% to about 25% by weight, from about 5% to about 30% by weight, from about 5% to about 25% by weight, from about 5% to about 20% by weight, from about 10% to about 30% by weight, from about 10% to about 25% by weight, from about 10% to about 20% by weight, from about 10% to about 15% by weight, from about 15% to about 30% by weight, from about 15% to about 25% by weight, from about 20% to about 30% by weight, and from about 25% to about 30% by weight. Other ranges are also contemplated.

The molar ratio is calculated based on the weight ratio amounts for the polyol and polyurethane in the intumescent coating. In many embodiments, the intumescent coating described herein has an NCO/OH ratio (isocyanate index) ranging from 0.5 to 1.2. In other embodiments, the intumescent coating has an NCO/OH ratio (isocyanate index) can, for example, range from 0.5 to 1.1, from 0.5 to 1.0, from 0.6 to 1.2, from 0.6 to 1.1, from 0.6 to 1.0, from 0.7 to 1.2, from 0.7 to 1.1, from 0.7 to 1.0, from 0.8 to 1.1, from 0.8 to 1.0, and from 0.9 to 1.1. Other ratios are also contemplated.

In some embodiments, the intumescent coating further comprises a dendritic polymer having hydroxyl groups, wherein the dendritic polymer has a hydroxyl number in the range of 80 to 800. In one embodiment, the intumescent coating further comprises a base coat polymer comprising at least one dendritic polyol and isocyanate.

In many embodiments, the intumescent coating may further comprise at least one solvent comprising an alcohol, an ester, an ether, a ketone, or combinations thereof. In some embodiments, at least one solvent may comprise one or more solvents such as ketone, ester, alcohol, glycol ether, and glycol ether ester solvents. Exemplary, non-limiting examples of solvents that may be useful include propylene glycol-n-butyl ether, t-butanol, di-sec-butyl ether, n-butanol, butyl carbitol acetate, n-butyl acetate, t-butyl acetate, acetone, propylene glycol methyl ether acetate, propylene carbonate, 2-butoxyethanol, dipropylene glycol n-butyl ether, propylene glycol n-butyl ether and the like, or combinations thereof. The total amount of solvent used in the intumescent coating described herein may be selected to provide the intumescent coating with a suitable viscosity for the application method as well as particular performance characteristics.

In many embodiments, the intumescent coating described herein is a clear coating composition. In some embodiments, the intumescent coating described herein is a pigmented coating. In one embodiment, the intumescent coating described herein may be pigmentable with pigmented pastes.

Further, the intumescent coating may comprise certain additives. In many embodiments, the intumescent coating described herein may further comprise at least one reactive diluent, at least one non-reactive diluent, at least one drier, at least one colorant, at least one pigment, at least one dispersant, at least one wax, at least one anti-skinning agent, at least one defoamer, at least one fungicide, at least one biocide, at least one mildewcide, or combinations thereof. In another embodiment, the intumescent coating may further comprise other polymers or polymer dispersions, surfactants, dispersants, defoamers, biocides, mildewcides, algaecides, thickeners, leveling agents, anti-settling agents, pH buffers, corrosion inhibitors, driers, anti-skinning agents, anti-cratering agents, anti-sag agents, heat stabilizers, UV absorbers/inhibitors, antioxidants, wetting agents, flatteners and other inert pigments (such as titanium dioxide, dyes, clay, amorphous and surface treated silica, calcium carbonate, and the like, and combinations thereof), flow agents, and the like, and various combinations thereof as needed for a particular application.

Further provided herein is a base coating comprising the intumescent coating described herein. Additionally provided is a substrate at least partially coated with the base coating. In many embodiments, the substrate comprises metal, plastics, wood, ceramics, cement, composites, or combinations thereof. In some embodiments, the substrate further comprises a top coat at least partially applied to the base coating, wherein the top coat comprises a silane resin. For this addition, the silane based topcoat may be at least partially coated over the basecoat in the first stages of the fire without impairing intumescence formation and to improve chemical-physical resistances.

Also provided herein is a process for producing an intumescent coating on a substrate comprising the method steps of: 1) applying the intumescent coating described herein on a substrate; and 2) curing the intumescent coating to provide a base coating on the substrate. In many embodiments, the substrate comprises metal, plastics, wood, ceramics, cement, composites, or combinations thereof.

Intumescent Coating with Urea-Based Resin

Also described herein is an intumescent coating comprising: 1) at least one cellulose film forming agent; 2) at least one urea-based resin; 3) at least one polyol; 4) at least one acid; and 5) at least one ammonium polyphosphate compound; wherein at least one polyol is reacted with at least one urea-based resin and at least one crosslinking catalyst. In some embodiments for this intumescent coating, there are no isocyanates. In some embodiments for this intumescent coating, there are substantially no isocyanates. In other embodiments for this intumescent coating, there are limited amounts of isocyanates. The intumescent coating described herein may provide a Class B rating, according to EN 13823 Single Burning Item. Although the intumescent coating described may be prepared as a clear coating, it may also be pigmented and still provide a Class B rating.

In many embodiments, at least one cellulose film forming agent in the intumescent coating is cellulose nitrate, cellulose ester, or combinations thereof. In some embodiments, the cellulose ester is cellulose acetate propionate (CAP), cellulose ester butyrate (CAB), or combinations thereof. Although not bound by theory, at least one cellulose film may allow the intumescent coating to be thermoplastic enough to produce intumescence when exposed to fire.

In many embodiments, at least one cellulose film forming agent comprises from 5% to 40% by weight of the intumescent coating. In other embodiments, at least one cellulose film can, for example, range from about 5% to about 35% by weight, from about 5% to about 30% by weight, from about 10% to about 40% by weight, from about 10% to about 35% by weight, from about 10% to about 30% by weight, from about 15% to about 40% by weight, from about 15% to about 35% by weight, from about 15% to about 30% by weight, from about 15% to about 25% by weight, from about 20% to about 40% by weight, and from about 20% to about 35% by weight. Other ranges are also contemplated.

In some embodiments, the at least one urea-based resin is a melamine, urea resin, modified urea resin, urea-formaldehyde resin (UF resin), monomethyl urea (MMU), or combinations thereof. Other urea-based resins are also contemplated. Non-urea-based resins are also contemplated as well.

In many embodiments, at least one urea-based resin comprises from 5% to 25% by weight of the intumescent coating. In other embodiments, at least one urea-based resin can, for example, range from about 5% to about 20% by weight, from about 5% to about 15% by weight, from about 10% to about 25% by weight, from about 10% to about 20% by weight, from about 10% to about 15% by weight, from about 15% to about 25% by weight, and from about 15% to about 20% by weight. Other ranges are also contemplated.

In many embodiments, at least one polyol has at least 2 hydroxyl groups. In some embodiments, at least one polyol comprises at least one polyether polyol, at least one polyester polyol, or combinations thereof. In one embodiment, at least one polyol comprises pentaerythritol, dipentaerythritol, tripentaerythritol, or combinations thereof. In one embodiment, at least one polyol comprises a melamine-based resin.

In many embodiments, at least one polyol comprises from 10% to 40% by weight of the intumescent coating. In other embodiments, at least one polyol can, for example, range from about 10% to about 35% by weight, from about 15% to about 40% by weight, from about 15% to about 35% by weight, from about 15% to about 30% by weight, from about 20% to about 40% by weight, from about 20% to about 35% by weight, from about 20% to about 30% by weight, from about 25% to about 40% by weight, from about 25% to about 35% by weight, from about 30% to about 40% by weight, and from about 30% to about 35% by weight. Other ranges are also contemplated.

In many embodiments, at least one acid is hydrochloric acid, phosphoric acid, sulfuric acid, phosphoric acid, sulfonic acid, or combinations thereof. In one embodiment, at least one acid is paratoluensolphonic acid. Other acids are also contemplated.

In many embodiments, at least one ammonium phosphate comprises monoammonium phosphate, diammonium phosphate, ammonium polyphosphate, or combinations thereof.

In many embodiments, at least one ammonium phosphate comprises from 10% to 50% by weight of the intumescent coating. In other embodiments, at least one ammonium phosphate can, for example, range from about 10% to about 45% by weight, from about 10% to about 40% by weight, from about 10% to about 35% by weight, from about 15% to about 50% by weight, from about 15% to about 45% by weight, from about 15% to about 40% by weight, from about 20% to about 50% by weight, from about 20% to about 45% by weight, from about 20% to about 40% by weight, from about 25% to about 50% by weight, from about 25% to about 45% by weight, from about 25% to about 40% by weight, from about 30% to about 50% by weight, and from about 30% to about 45% by weight. Other ranges are also contemplated.

In many embodiments, at least one crosslinking catalyst comprises 1) at least one compound having two or more hydroxyl groups, 2) at least one urea or modified urea resin with at least one acid, 3) at least one isocyanate, or 4) combinations thereof. In one embodiment, the at least one isocyanate is toluene diisocyanate (TDI), toluene diisocyanate (TDI) derivative, methylene diphenyl diisocyanate (MDI), methylene diphenyl diisocyanate (MDI) derivative, hexamethylene diisocyanate (HDI), hexamethylene diisocyanate (HDI) derivative, or combinations thereof.

In many embodiments, at least one crosslinking catalyst comprises from 3% to 30% by weight of the intumescent coating when the crosslinking catalyst is measured as dry and without solvents. In other embodiments, at least one crosslinker can, for example, range from about 3% to about 25% by weight, from about 5% to about 30% by weight, from about 5% to about 25% by weight, from about 5% to about 20% by weight, from about 10% to about 30% by weight, from about 10% to about 25% by weight, from about 10% to about 20% by weight, from about 10% to about 15% by weight, from about 15% to about 30% by weight, from about 15% to about 25% by weight, from about 20% to about 30% by weight, and from about 25% to about 30% by weight. Other ranges are also contemplated.

The molar ratio is calculated based on the weight ratio amounts for the polyol and polyurethane in the intumescent coating. In many embodiments, the intumescent coating described herein has an NCO/OH ratio (isocyanate index) ranging from 0.5 to 1.2. In other embodiments, the intumescent coating has an NCO/OH ratio (isocyanate index) can, for example, range from 0.5 to 1.1, from 0.5 to 1.0, from 0.6 to 1.2, from 0.6 to 1.1, from 0.6 to 1.0, from 0.7 to 1.2, from 0.7 to 1.1, from 0.7 to 1.0, from 0.8 to 1.1, from 0.8 to 1.0, and from 0.9 to 1.1. Other ratios are also contemplated.

In some embodiments, the intumescent coating further comprises a dendritic polymer having hydroxyl groups, wherein the dendritic polymer has a hydroxyl number in the range of 80 to 800. In one embodiment, the intumescent coating further comprises a base coat polymer comprising at least one dendritic polyol and isocyanate.

In many embodiments, the intumescent coating may further comprise at least one solvent comprising an alcohol, an ester, an ether, a ketone, or combinations thereof. In some embodiments, at least one solvent may comprise one or more solvents such as ketone, ester, alcohol, glycol ether, and glycol ether ester solvents. Exemplary, non-limiting examples of solvents that may be useful include propylene glycol-n-butyl ether, t-butanol, di-sec-butyl ether, n-butanol, butyl carbitol acetate, n-butyl acetate, t-butyl acetate, acetone, propylene glycol methyl ether acetate, propylene carbonate, 2-butoxyethanol, dipropylene glycol n-butyl ether, propylene glycol n-butyl ether and the like, or combinations thereof. The total amount of solvent used in the intumescent coating described herein may be selected to provide the intumescent coating with a suitable viscosity for the application method as well as particular performance characteristics.

In many embodiments, the intumescent coating described herein is a clear coating composition. In some embodiments, the intumescent coating described herein is a pigmented coating. In one embodiment, the intumescent coating described herein may be pigmentable with pigmented pastes.

Further, the intumescent coating may comprise certain additives. In many embodiments, the intumescent coating described herein may further comprise at least one reactive diluent, at least one non-reactive diluent, at least one drier, at least one colorant, at least one pigment, at least one dispersant, at least one wax, at least one anti-skinning agent, at least one defoamer, at least one fungicide, at least one biocide, at least one mildewcide, or combinations thereof. In another embodiment, the intumescent coating may further comprise other polymers or polymer dispersions, surfactants, dispersants, defoamers, biocides, mildewcides, algaecides, thickeners, leveling agents, anti-settling agents, pH buffers, corrosion inhibitors, driers, anti-skinning agents, anti-cratering agents, anti-sag agents, heat stabilizers, UV absorbers/inhibitors, antioxidants, wetting agents, flatteners and other inert pigments (such as titanium dioxide, dyes, clay, amorphous and surface treated silica, calcium carbonate, and the like, and combinations thereof), flow agents, and the like, and various combinations thereof as needed for a particular application.

Further provided herein is a base coating comprising the intumescent coating described herein. Additionally provided is a substrate at least partially coated with the base coating. In many embodiments, the substrate comprises metal, plastics, wood, ceramics, cement, composites, or combinations thereof. In some embodiments, the substrate further comprises a top coat at least partially applied to the base coating, wherein the top coat comprises a silane resin. For this addition, the silane based topcoat may be at least partially coated over the basecoat in the first stages of the fire without impairing intumescence formation and to improve chemical-physical resistances.

Also provided herein is a process for producing an intumescent coating on a substrate comprising the method steps of: 1) applying the intumescent coating described herein on a substrate; and 2) curing the intumescent coating to provide a base coating on the substrate. In many embodiments, the substrate comprises metal, plastics, wood, ceramics, cement, composites, or combinations thereof.

### Experimental Results

The classification parameter FIGRA, FIre Growth Rate, provides a way to classify the fire properties of building products for the purpose of the Construction Products Derivative (CPD) and is the main parameter for classification of building products based on the SBI (Single Burning Item) test. It predicts burning behavior of a large variety of building products in reference scenarios based on real life fire scenarios. FIGRA is defined as the growth rate of the burning intensity, HRR, during a test (e.g. SBI). FIGRA is calculated as the maximum value of the function (heat release rate)/(elapsed test time) and provided as W/s.

In addition, certain threshold values of HRR and the total heat release rate must first be reached before FIGRA is calculated. Threshold values are needed to avoid that very small and early values of HRR are included as this leads to unrealistic FIGRA values. The detailed definition of FIGRA can be found in EN 13823 Single Burning Item (SBI). SBI evaluates the potential contribution of a surface lining to the development of a fire. It simulates a single burning item in a corner of a room. The test is used for the European classes A1, A2, B, C and D. For the fire classification system, the following ratings and test methods are provided below in Table 1.

TABLE 1
Fire Ratings

| | | Classification | |
|---|---|---|---|
| Class | Test method(s) | criteria | Additional classification |
| A1 | [symbol] | [symbol] | [symbol] |
| | [symbol] | [symbol] | |
| A2 | [symbol] | [symbol] | Smoke production [symbol] and |
| | [symbol] | [symbol] | Flaming droplets/particles ( [symbol] ) |
| | [symbol] | [symbol] | |
| B | [symbol] | [symbol] | Smoke production [symbol] and |
| | [symbol] | [symbol] | Flaming droplets/particles ( [symbol] ) |
| C | [symbol] | [symbol] | Smoke production [symbol] and |
| | [symbol] | [symbol] | Flaming droplets/particles ( [symbol] ) |
| D | [symbol] | [symbol] | Smoke production [symbol] and |
| | [symbol] | [symbol] | Flaming droplets/particles ( [symbol] ) |
| E | [symbol] | [symbol] | Flaming droplets/particles ( [symbol] ) |

| | |
|---|---|
| F | No performance determined |

[symbol]

[symbol]

[symbol]

[symbol]

[symbol]

[symbol]

[symbol]

[symbol]

[symbol]

[symbol]

indicates data missing or illegible when filed

Based on EN 13823, the following testing was performed below in Table 2. Results were prepared both in with vacuum and high pressure equipment by Cone Calorimetry method according to EN 13823-2020 for FIGRA and by actual FIGRA testing by Single Burning Item (SBI) method according to EN 13823-2020. TSP, or Total Smoke Reduction, was also measured.

TABLE 2

| | pseudo | FIGRA | FIGRA | Cone | TSP | TSP | Class |
|---|---|---|---|---|---|---|---|
| | FIGRA | calc | Avg | TSP | calc | Avg | SBI |
| Example 1A (2 coats basecoat + | 0.856493 | 86 | 144 | 155 | 52 | 53 | C s2 |
| 1 coat topcoat) - 20 mm MDF | | | | | | | d0 |
| Example 1B (2 coats basecoat + | 2.010677 | 202 | | 159 | 54 | | |
| 1 coat topcoat) - 20 mm MDF | | | | | | | |
| Example 1A (2 coats basecoat + | 0.620012 | 62 | 54 | 234 | 79 | 119 | B s2 |
| 1 coat topcoat) - 19 mm pine | | | | | | | d0 |
| Example 1B (2 coats basecoat + | 0.462382 | 46 | | 471 | 159 | | |
| 1 coat topcoat) - 19 mm pine | | | | | | | |
| Example 1A (2 coats basecoat + | 0.515738 | 52 | 99 | 214 | 72 | 60 | B s2 |
| 1 coat topcoat) with insulator | | | | | | | d0 |
| coat - 20 mm MDF | | | | | | | |
| Example 1B (2 coats basecoat + | 1.450146 | 146 | | 143 | 48 | | |
| 1 coat topcoat) with insulator | | | | | | | |
| coat - 20 mm MDF | | | | | | | |

From Table 2, Class B may be achieved on pine substrate using the intumescent coating described herein. Further, Class B may be achieved on MDF substrate using the intumescent coating described herein along with an insulator coat or sealing coat. However, the intumescent coating is absorbed into the wood in the first two results (with a FIGRA average of 144), resulting in a Class C rating.

Further, additional testing provided the following data in Table 3 based on EN 13823.

TABLE 3

| | | | | | SBI | | | | | SBI | Pred |
|---|---|---|---|---|---|---|---|---|---|---|---|
| | | | | Cone | pred | | | | Cone | pred | SBI |
| coat system | Test 1 | Test 2 | Test 3 | FIGRA | FIGRA | Test 1 | Test 2 | Test 3 | TSP | TSP | class |
| Example 1 (2 coats clear | 1.5198 | 0.9478 | 1.0373 | 1.1683 | 117 | 194 | 234 | 256 | 228 | 77 | B s2 |
| basecoat, 1 coat topcoat) | | | | | | | | | | | d0 |
| Example 2 (2 coats clear | 1.9428 | 1.6017 | 2.2979 | 1.9474 | 196 | 213 | 200 | 250 | 221 | 74 | C s2 |
| basecoat + FR additive, | | | | | | | | | | | d0 |
| 1 coat topcoat) | | | | | | | | | | | |
| Example 3A (2 coats | 0.9880 | 1.5970 | 1.2940 | 1.2931 | 130 | 315 | 253 | 338 | 302 | 102 | C s2 |
| basecoat with 2% black | | | | | | | | | | | d0 |
| paste, 1 coat topcoat) | | | | | | | | | | | |
| Example 3B 2 coats | 1.7979 | 2.2875 | 1.7559 | 1.9471 | 196 | 213 | 221 | 169 | 201 | 68 | C s2 |
| basecoat with 2% black | | | | | | | | | | | d0 |
| paste, 1 coat topcoat | | | | | | | | | | | |
| Example 3C (2 coats | 1.6962 | 1.781411 | 1.5886 | 1.6887 | 170 | 174 | 210 | 156 | 180 | 61 | C s2 |
| basecoat with 5% white | | | | | | | | | | | d0 |
| paste, 1 coat topcoat) | | | | | | | | | | | |
| Example 3D (2 coats | 1.2065 | 2.0314 | 1.2047 | 1.4809 | 149 | 178 | 210 | 220 | 203 | 68 | C s2 |
| basecoat with 5% red | | | | | | | | | | | d0 |
| paste, 1 coat topcoat) | | | | | | | | | | | |
| Example 4 (2 coats | 1.7640 | 0.9999 | 2.0655 | 1.6010 | 162 | 223 | 246 | 255 | 241 | 81 | C s2 |
| basecoat with 2% black | | | | | | | | | | | d0 |
| paste + FR additive, 1 | | | | | | | | | | | |
| coat topcoat) | | | | | | | | | | | |

From the results in Table 3, Class B may be achieved on MDF substrate (20 mm) for Example 1. Due to the absorption characteristic of the MDF, pigments or an insulator coat (as shown in Table 2) may provide improved ratings for the fire class. The addition of a fire retardant (FR) to the intumescent coating (from Example 1) in Example 2 did not provide a Class B rating. Further, adding certain amounts of pigmented pastes, even with the addition of a fire retardant additive in Example 4, did not provide a Class B rating.

TABLE 4

| | SBI FIGRA 0.2 | | | SBI SMOGRA |
|---|---|---|---|---|
| coat system on EN13823 (SBI) test | (MJ) | SBI THR600s (MJ) | SBI TSP600s (m²) | (m²/s²) |
| Example 1A: 2 coats clear basecoat, 1 coat topcoat | 88.8 | 5.9 | 70.8 | 33.7 |
| Example 1B: 2 coats clear basecoat, 1 coat topcoat | 97.3 | 6.3 | 44.6 | 15.8 |
| Example 1C: 2 coats clear basecoat, 1 coat topcoat | 99.2 | 5.5 | 59.0 | 14.6 |
| Example 2: 2 coats clear basecoat + 3% white pigmented | 70.0 | 7.6 | 69.0 | 22.8 |
| paste, 1 coat topcoat | | | | |
| Example 3: 2 coats clear basecoat + 3% red pigmented paste, | 90.5 | 5.6 | 37.0 | 9.8 |
| 1 coat topcoat | | | | |
| Example 4: 2 coats clear basecoat + 0.5% black pigmented | 84.8 | 1.6 | 54.6 | 12.9 |
| paste, 1 coat topcoat | | | | |

For Table 4, nearly all Examples achieved a Class B rating on MDF (20 mm) except the white pigmented sample (Example 2). Example 2 did not achieve a Class B rating only due to the THR600 rating of 7.5. For Class B, it must be less than or equal to 7.5. It is speculated that adjustments to the amount of white pigmented paste may allow a white pigmented system to achieve a Class B rating.

### Embodiments

The following embodiments are contemplated. All combinations of features and embodiments are contemplated.

Embodiment 1: An intumescent coating comprising: 1) at least one cellulose film forming agent; 2) at least one polyol; 3) at least one ammonium polyphosphate compound; and 4) at least one crosslinker; wherein at least one polyol is reacted with at least one crosslinker.

Embodiment 2: An embodiment of Embodiment 1, wherein at least one cellulose film forming agent is cellulose nitrate, cellulose ester, or combinations thereof.

Embodiment 3: An embodiment of Embodiment 2, wherein the cellulose ester is cellulose acetate propionate (CAP), cellulose ester butyrate (CAB), or combinations thereof.

Embodiment 4: An embodiment of any of Embodiments 1-3, wherein at least one polyol has at least 2 hydroxyl groups.

Embodiment 5: An embodiment of Embodiment 4, wherein at least one polyol comprises at least one polyether polyol, at least one polyester polyol, or combinations thereof.

Embodiment 6: An embodiment of Embodiment 4, wherein at least one polyol comprises pentaerythritol, dipentaerythritol, tripentaerythritol, or combinations thereof.

Embodiment 7: An embodiment of any of Embodiments 1-6, wherein at least one ammonium phosphate comprises monoammonium phosphate, diammonium phosphate, ammonium polyphosphate, or combinations thereof.

Embodiment 8: An embodiment of any of Embodiments 1-7, wherein at least one crosslinker comprises 1) at least one compound having two or more hydroxyl groups, 2) at least one urea or modified urea resin with at least one acid, 3) at least one isocyanate, or 4) combinations thereof.

Embodiment 9: An embodiment of Embodiment 8, wherein the at least one isocyanate is toluene diisocyanate (TDI), toluene diisocyanate (TDI) derivative, methylene diphenyl diisocyanate (MDI), methylene diphenyl diisocyanate (MDI) derivative, hexamethylene diisocyanate (HDI), hexamethylene diisocyanate (HDI) derivative, or combinations thereof.

Embodiment 10: An embodiment of any of Embodiments 1-9, wherein a molar ratio of OH/NCO is 0.5 to 1.2.

Embodiment 11: An embodiment of any of Embodiments 1-10 further comprising a dendritic polymer having hydroxyl groups, wherein the dendritic polymer has a hydroxyl number in the range of 80 to 800.

Embodiment 12: An embodiment of any of Embodiments 1-11, further comprising a base coat polymer comprising at least one dendritic polyol and isocyanate.

Embodiment 13: An embodiment of any of Embodiments 1-12 further comprising at least one solvent comprising an alcohol, an ester, an ether, a ketone, or combinations thereof.

Embodiment 14: An embodiment of any of Embodiments 1-13, wherein the intumescent coating is a clear coating composition.

Embodiment 15: An embodiment of any of Embodiments 1-14 further comprising at least one reactive diluent, at least one non-reactive diluent, at least one drier, at least one colorant, at least one pigment, at least one dispersant, at least one wax, at least one anti-skinning agent, at least one defoamer, at least one fungicide, at least one biocide, at least one mildewcide, or combinations thereof.

Embodiment 16: A base coating comprising the intumescent coating of any of Embodiments 1-15.

Embodiment 17: A substrate at least partially coated with the base coating of Embodiment 16.

Embodiment 18: An embodiment of Embodiment 17, wherein the substrate comprises metal, plastics, wood, ceramics, cement, composites, or combinations thereof.

Embodiment 19: An embodiment of any of Embodiments 17-18 further comprising a top coat at least partially applied to the base coating, wherein the top coat comprises a silane resin.

Embodiment 20: A process for producing an intumescent coating on a substrate comprising the method steps of: 1) applying the intumescent coating of any of Embodiments 1 to 15 on a substrate; and 2) curing the intumescent coating to provide a base coating on the substrate.

Embodiment 21: An embodiment of Embodiment 20, wherein the substrate comprises metal, plastics, wood, ceramics, cement, composites, or combinations thereof.

Embodiment 22: An intumescent coating comprising: 1) at least one cellulose film forming agent; 2) at least one urea-based resin; 3) at least one polyol; 4) at least one acid; and 5) at least one ammonium polyphosphate compound; wherein at least one polyol is reacted with at least one urea-based resin and at least one crosslinking catalyst.

Embodiment 23: An embodiment of Embodiment 22, wherein at least one cellulose film forming agent is cellulose nitrate, cellulose ester, or combinations thereof.

Embodiment 24: An embodiment of Embodiment 23, wherein the cellulose ester is cellulose acetate propionate (CAP), cellulose ester butyrate (CAB), or combinations thereof.

Embodiment 25: An embodiment of any of Embodiments 22-24, wherein the at least one urea-based resin is a melamine, urea resin, modified urea resin, urea-formaldehyde resin (UF resin), monomethyl urea (MMU), or combinations thereof.

Embodiment 26: An embodiment of any of Embodiments 22-25, wherein at least one polyol has at least 2 hydroxyl groups.

Embodiment 27: An embodiment of Embodiment 26, wherein at least one polyol comprises at least one polyether polyol, at least one polyester polyol, or combinations thereof.

Embodiment 28: An embodiment of Embodiment 26, wherein at least one polyol comprises pentaerythritol, dipentaerythritol, tripentaerythritol, or combinations thereof.

Embodiment 29: An embodiment of any of Embodiments 22-28, wherein at least one acid is hydrochloric acid, phosphoric acid, sulfuric acid, phosphoric acid, sulfonic acid, or combinations thereof.

Embodiment 30: An embodiment of any of Embodiments 22-29, wherein at least one ammonium phosphate comprises monoammonium phosphate, diammonium phosphate, ammonium polyphosphate, or combinations thereof.

Embodiment 31: An embodiment of any of Embodiments 22-30 further comprising at least one crosslinking catalyst, wherein the at least one crosslinking catalyst comprises 1) at least one compound having two or more aldehyde groups, acetals or hemiacetals of the aldehydes, 2) at least one compound having two or more hydroxyl groups, 3) at least one isocyanate, or 4) combinations thereof.

Embodiment 32: An embodiment of Embodiment 31, wherein the at least one isocyanate is toluene diisocyanate (TDI), toluene diisocyanate (TDI) derivative, methylene diphenyl diisocyanate (MDI), methylene diphenyl diisocyanate (MDI) derivative, hexamethylene diisocyanate (HDI), hexamethylene diisocyanate (HDI) derivative, or combinations thereof.

Embodiment 33: An embodiment of any of Embodiments 22-32, wherein a molar ratio of OH/NCO is 0.5 to 1.2.

Embodiment 34: An embodiment of any of Embodiments 22-33 further comprising a dendritic polymer having hydroxyl groups, wherein the dendritic polymer has a hydroxyl number in the range of 80 to 800.

Embodiment 35: An embodiment of any of Embodiments 22-34 further comprising a base coat polymer comprising at least one dendritic polyol and isocyanate.

Embodiment 36: An embodiment of any of Embodiments 22-35 further comprising at least one solvent comprising an alcohol, an ester, an ether, a ketone, or combinations thereof.

Embodiment 37: An embodiment of any of Embodiments 22-36, wherein the intumescent coating is a clear coating composition.

Embodiment 38: An embodiment of any of Embodiments 22-37 further comprising at least one reactive diluent, at least one non-reactive diluent, at least one drier, at least one colorant, at least one pigment, at least one dispersant, at least one wax, at least one anti-skinning agent, at least one defoamer, at least one fungicide, at least one biocide, at least one mildewcide, or combinations thereof.

Embodiment 39: A base coating comprising the intumescent coating of any of Embodiments 22-38.

Embodiment 40: A substrate at least partially coated with the base coating of Embodiment 39.

Embodiment 41: An embodiment of Embodiment 40, wherein the substrate comprises metal, plastics, wood, ceramics, cement, composites, or combinations thereof.

Embodiment 42: An embodiment of any of Embodiments 40-41 further comprising a top coat at least partially applied to the base coating, wherein the top coat comprises a silane resin.

Embodiment 43: A process for producing an intumescent coating on a substrate comprising the method steps of: 1) applying the intumescent coating of any of Embodiments 22 to 38 on a substrate; and 2) curing the intumescent coating to provide a base coating on the substrate.

Embodiment 44: An embodiment of Embodiment 43, wherein the substrate comprises metal, plastics, wood, ceramics, cement, composites, or combinations thereof.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An intumescent coating comprising:
at least one cellulose film forming agent;
at least one polyol;
at least one ammonium polyphosphate compound; and
at least one crosslinker;
wherein at least one polyol is reacted with at least one crosslinker.

2. The intumescent coating of claim 1, wherein at least one cellulose film forming agent is cellulose nitrate, cellulose ester, or combinations thereof and wherein the cellulose ester is cellulose acetate propionate (CAP), cellulose ester butyrate (CAB), or combinations thereof.

3. (canceled)

4. (canceled)

5. The intumescent coating of claim 1, wherein at least one polyol comprises at least one polyether polyol, at least one polyester polyol, or combinations thereof.

6. The intumescent coating of claim 1, wherein at least one polyol comprises pentaerythritol, dipentaerythritol, tripentaerythritol, or combinations thereof.

7. The intumescent coating of claim 1, wherein at least one ammonium phosphate comprises monoammonium phosphate, diammonium phosphate, ammonium polyphosphate, or combinations thereof.

8. The intumescent coating of claim 1, wherein at least one crosslinker comprises 1) at least one compound having two or more hydroxyl groups, 2) at least one urea or modified urea resin with at least one acid, 3) at least one isocyanate, or 4) combinations thereof.

9. The intumescent coating of claim 8, wherein the at least one isocyanate is toluene diisocyanate (TDI), toluene diisocyanate (TDI) derivative, methylene diphenyl diisocyanate (MDI), methylene diphenyl diisocyanate (MDI) derivative, hexamethylene diisocyanate (HDI), hexamethylene diisocyanate (HDI) derivative, or combinations thereof.

10. (canceled)

11. The intumescent coating of claim 1 further comprising a dendritic polymer having hydroxyl groups, wherein the dendritic polymer has a hydroxyl number in the range of 80 to 800.

12. The intumescent coating of claim 1 further comprising a base coat polymer comprising at least one dendritic polyol and isocyanate.

13. (canceled)

14. (canceled)

15. The intumescent coating of claim 1 further comprising at least one reactive diluent, at least one non-reactive diluent, at least one drier, at least one colorant, at least one pigment, at least one dispersant, at least one wax, at least one anti-skinning agent, at least one defoamer, at least one fungicide, at least one biocide, at least one mildewcide, or combinations thereof.

16. (canceled)

17. A substrate at least partially coated with the intumescent coating of claim 1, wherein the substrate comprises metal, plastics, wood, ceramics, cement, composites, or combinations thereof.

18. (canceled)

19. The substrate of claim 17, further comprising a top coat at least partially applied to the intumescent coating, wherein the top coat comprises a silane resin.

20. (canceled)

21. (canceled)

22. An intumescent coating comprising:
at least one cellulose film forming agent;
at least one urea-based resin;
at least one polyol;
at least one acid; and
at least one ammonium polyphosphate compound;
wherein at least one polyol is reacted with at least one urea-based resin and at least one crosslinking catalyst.

23. The intumescent coating of claim 22, wherein at least one cellulose film forming agent is cellulose nitrate, cellulose ester, or combinations thereof and wherein the cellulose ester is cellulose acetate propionate (CAP), cellulose ester butyrate (CAB), or combinations thereof.

24. (canceled)

25. The intumescent coating of claim 22, wherein the at least one urea-based resin is a melamine, urea resin, modified urea resin, urea-formaldehyde resin (UF resin), monomethyl urea (MMU), or combinations thereof.

26. (canceled)

27. The intumescent coating of claim 22, wherein at least one polyol comprises at least one polyether polyol, at least one polyester polyol, or combinations thereof.

28. The intumescent coating of claim 22, wherein at least one polyol comprises pentaerythritol, dipentaerythritol, tripentaerythritol, or combinations thereof.

29. The intumescent coating of claim 22, wherein at least one acid is hydrochloric acid, phosphoric acid, sulfuric acid, phosphoric acid, sulfonic acid, or combinations thereof.

30. The intumescent coating of claim 22, wherein at least one ammonium phosphate comprises monoammonium phosphate, diammonium phosphate, ammonium polyphosphate, or combinations thereof.

31. The intumescent coating of claim 22, further comprising at least one crosslinking catalyst, wherein the at least one crosslinking catalyst comprises 1) at least one compound having two or more aldehyde groups, acetals or hemiacetals of the aldehydes, 2) at least one compound having two or more hydroxyl groups, 3) at least one isocyanate, or 4) combinations thereof.

32. The intumescent coating of claim 31, wherein the at least one isocyanate is toluene diisocyanate (TDI), toluene diisocyanate (TDI) derivative, methylene diphenyl diisocyanate (MDI), methylene diphenyl diisocyanate (MDI) derivative, hexamethylene diisocyanate (HDI), hexamethylene diisocyanate (HDI) derivative, or combinations thereof.

33. (canceled)

34. The intumescent coating of claim 22 further comprising a dendritic polymer having hydroxyl groups, wherein the dendritic polymer has a hydroxyl number in the range of 80 to 800.

35. The intumescent coating of claim 22 further comprising a base coat polymer comprising at least one dendritic polyol and isocyanate.

36. (canceled)

37. (canceled)

38. The intumescent coating of claim 22 further comprising at least one reactive diluent, at least one non-reactive diluent, at least one drier, at least one colorant, at least one pigment, at least one dispersant, at least one wax, at least one anti-skinning agent, at least one defoamer, at least one fungicide, at least one biocide, at least one mildewcide, or combinations thereof.

39. (canceled)

40. A substrate at least partially coated with the base coating of claim 22, wherein the substrate comprises metal, plastics, wood, ceramics, cement, composites, or combinations thereof.

41. (canceled)

42. The substrate of claim 40, further comprising a top coat at least partially applied to the intumescent coating, wherein the top coat comprises a silane resin.

43. (canceled)

44. (canceled)
